(19) United States
(12) Patent Application Publication
(10) Pub. No.: US 2015/0154211 A1
(43) Pub. Date: Jun. 4, 2015

(54) FILE STORAGE SERVICE SYSTEM AND METHOD FOR THE SAME

(71) Applicants: Kazumasa Matsubara, Tokyo (JP); Hitoshi Kamei, Tokyo (JP); Mitsuo Hayasaka, Tokyo (JP)

(72) Inventors: Kazumasa Matsubara, Tokyo (JP); Hitoshi Kamei, Tokyo (JP); Mitsuo Hayasaka, Tokyo (JP)

(73) Assignee: HITACHI, LTD., Tokyo (JP)

(21) Appl. No.: 14/347,192

(22) PCT Filed: Apr. 2, 2013
(86) PCT No.: PCT/JP2013/060089

§ 371 Date: Mar. 25, 2014

(51) Int. Cl. G06F 17/30; H04L 29/06

(52) U.S. Cl. CPC G06F 17/30091; H04L 67/42

(57) ABSTRACT

In a file storage service system, a computer stores files in a hybrid cloud. The computer comprises an extension metadata table which stores file storage conditions and target availability and an arrangement planned cloud table which stores a first identifier of a first cloud included in the hybrid cloud. The computer further comprises: an arrangement number calculation unit which selects a second cloud included in the hybrid cloud and satisfying the storage conditions and stores an identifier of the selected second cloud as the first identifier of the first cloud in the arrangement planned cloud table when availability of the selected second cloud satisfies the target availability; and a file arrangement management unit which stores a file uploaded from a client terminal in the first cloud identified by the first identifier stored in the arrangement planned cloud table by referring to the extension metadata table.

### TECHNICAL FIELD

The present invention relates to a file storage service system employing a hybrid cloud including a private cloud and public clouds, and to a method for such a file storage service system.

### BACKGROUND ART

The use of computer systems is essential in companies, public institutions, etc. today and once data used in such systems is lost, in many cases it will be difficult to restore the system. Importance of data protection is increasing also from the viewpoints of internal control and compliance. In recent years, storing of data in public storage (typified by the so-called cloud storage) is becoming more and more common. In contrast, the amount of data stored in private storage is also increasing in consideration of factors such as performance. Thus, there is an increasing demand for hybrid clouds employing private storage while taking advantage of public storage.

As a method for data protection, there is a conventional technology duplicating data and storing the duplicated data in a plurality of storage devices as disclosed in Patent Literature 1. By use of the technology, even when data stored in one storage device is lost due to disaster, the data can be recovered by using other storage devices storing the duplicated data.

There also exists a technology carrying out the data duplication in consideration of wide-area disaster and thereby optimizing arrangement of data so as to reduce the data loss risk even in cases of disaster damaging a plurality of storage device, as disclosed in Patent Literature 2.

### PRIOR ART LITERATURE

### Patent Literature

Patent Literature 1: JP-2011-34164-A

Patent Literature 2: PCT/JP2012/002833

### SUMMARY OF THE INVENTION

### Problem to be Solved by the Invention

In the technologies of the Patent Literatures 1 and 2, the storage in which data should be duplicated and stored is configured in consideration of the performance and capacity of the storage and the disaster risk, and even when duplicated data of data stored in the private cloud has already been stored in a public cloud, the duplicated data is stored also in the private cloud. This leads to problems such as excessive consumption of storage resources of the private cloud and increase in the management cost.

It is therefore the primary object of the present invention to reduce the number of duplication files (duplicated files of a file stored in a public cloud) stored in the private cloud and cut down the management cost which changes depending on the number of duplication files.

### Means for Solving the Problem

A file storage service system disclosed in this description is configured by connecting a client terminal, a hybrid cloud for storing a file uploaded from the client terminal, and a computer via a network. The computer comprises: an extension metadata table which stores conditions and target availability for storage of a file to the hybrid cloud; an arrangement planned cloud table which stores a first identifier of a first cloud included in the hybrid cloud in association with the extension metadata table; an arrangement number calculation unit which selects a second cloud included in the hybrid cloud and satisfying the conditions stored in the extension metadata table and stores an identifier of the selected second cloud as the first identifier of the first cloud in the arrangement planned cloud table when availability of the selected second cloud satisfies the target availability; and a file arrangement management unit which refers to the extension metadata table associated with a file in response to reception of the file from the client terminal via the network, acquires the first identifier of the first cloud stored in the arrangement planned cloud table, and stores the file in the first cloud identified by the acquired first identifier.

### Effect of the Invention

According to the present invention, the number of duplication files stored in the public clouds and the private cloud can be reduced and the management cost can be cut down while satisfactory file storage availability is secured.

### BRIEF DESCRIPTION OF THE DRAWINGS

FIG. 1 shows an example of the configuration of a hybrid cloud system.

FIG. 2 shows an example of the configuration of a client terminal.

FIG. 3 shows an example of the configuration of a management terminal.

FIG. 4 shows an example of the configuration of a gateway.

FIG. 5 shows an example of a cloud configuration definition table.

FIG. 6 shows an example of an extension metadata table.

FIG. 7 shows an example of an arrangement planned cloud table.

FIG. 8 shows an example of a user management table.

FIG. 9 shows an example of a file arrangement management table.

FIG. 10 shows an example of the configuration of a private cloud.

FIG. 11 is an example of a processing flow chart of a file arrangement management unit.

FIG. 12 is an example of a processing flow chart of the file arrangement management unit.

FIG. 13 shows an example of information displayed on a user management cloud configuration definition table setting screen.

FIG. 14 is an example of a processing flow chart of a cloud configuration management unit.

FIG. 15 is an example of a processing flow chart of an arrangement number calculation unit.

FIG. 16 shows an example of a user management table setting screen.

FIG. 17 is an example of a processing flow chart of a user management table update unit.

FIG. 18 shows an example of an extension metadata setting screen.

FIG. 19 is an example of a processing flow chart of an extension metadata table update unit.

FIG. 20 shows an example of a file extension metadata update screen of the management terminal.

### MODES FOR CARRYING OUT THE INVENTION

An embodiment of a hybrid cloud system will be described below by taking an example of a file storage system storing files in one private cloud (storage) and three public clouds (storage) via a computer (gateway). The name “hybrid cloud system” is used in the sense that both types of clouds (private cloud, public cloud) are used. The private cloud and the public cloud differ from each other in availability information (hereinafter referred to as “SLA”) specified in the Service Level Agreement, cost, performance, etc. The SLA means the contents and quality of a service (e.g., cloud system) determined in an agreement between the provider and the recipient (user, customer) of the service.

In this embodiment, the explanation will be given by taking availability (availability factor) as an example of the SLA. Private clouds and public clouds are generally operated by different managers/carriers. A private cloud is a cloud limited to a particular user (client terminal), whereas a public cloud is a cloud open to the public. The cloud service in this embodiment is a file storage service, and thus the private cloud and the public cloud can be paraphrased as a private storage service and a public storage service, respectively. In general, private clouds have higher SLA compared to public clouds.

The file storage service system in this embodiment is configured by connecting a client terminal, a hybrid cloud for storing a file uploaded from the client terminal, and a computer (gateway) via a network. The computer (gateway) comprises an extension metadata table which stores conditions and target availability for storage of a file to the hybrid cloud and an arrangement planned cloud table which stores a first identifier of a first cloud included in the hybrid cloud in association with the extension metadata table. The computer (gateway) further comprises: an arrangement number calculation unit which selects a second cloud included in the hybrid cloud and satisfying the conditions stored in the extension metadata table and stores an identifier of the selected second cloud as the first identifier of the first cloud in the arrangement planned cloud table when availability of the selected second cloud satisfies the target availability; and a file arrangement management unit which refers to the extension metadata table associated with a file in response to reception of the file from the client terminal via the network, acquires the first identifier of the first cloud stored in the arrangement planned cloud table, and stores the file in the first cloud identified by the acquired first identifier.

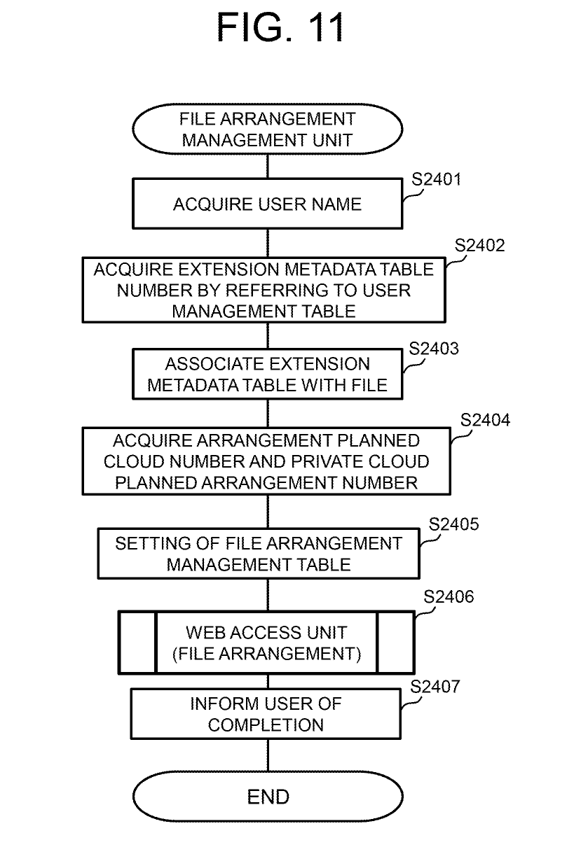

In the following, this embodiment will be described in the order of (1) Configuration of Hybrid Cloud System and Table Configuration, etc. Used in Hybrid Cloud System, (2) Process for Arranging Files in Hybrid Cloud System (FIG. 11), (3) Process for Reading Out File from Hybrid Cloud System, (4) Process Executed in Response to Configuration Change of Public Cloud Constituting Hybrid Cloud System, (5) Process Executed in Response to Change in File Arrangement Specification, and (6) Process Executed in Response to Change in File Arrangement Condition. The “file arrangement specification” and the “file arrangement condition” are in the following relationship: A file arrangement specification is a combination of several file arrangement conditions. A plurality of arrangement specifications are prepared. Each arrangement condition is represented as an item of an extension metadata table which will be explained later. Each arrangement specification is represented as an extension metadata table.

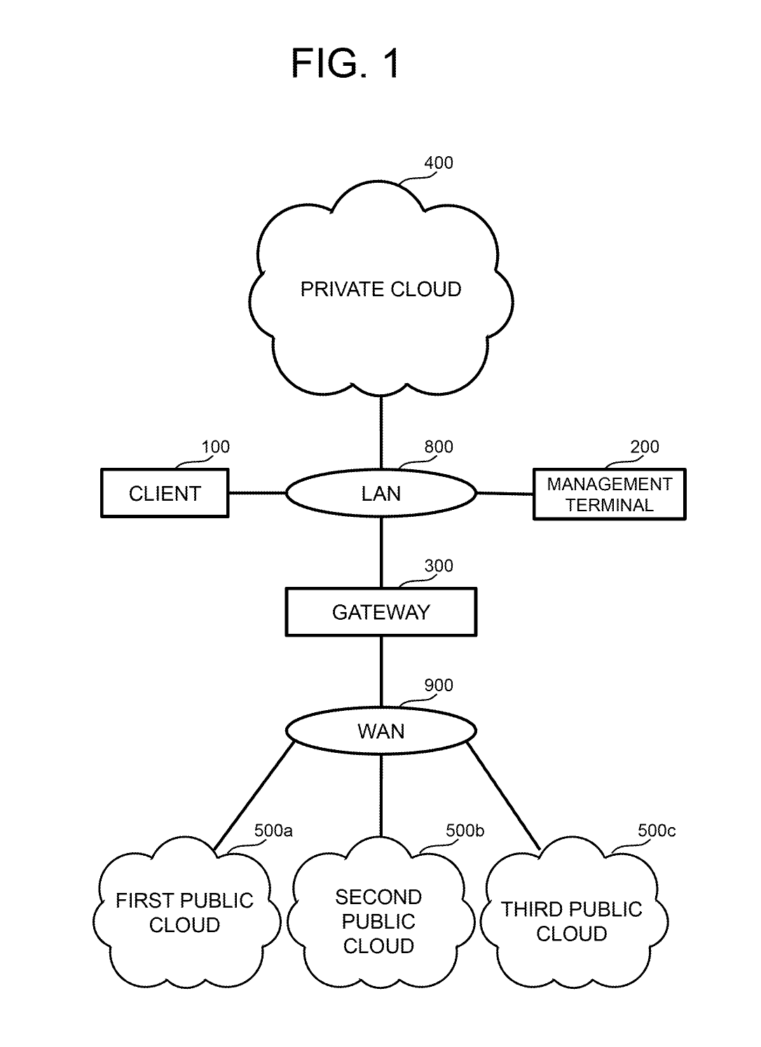

(1) Configuration of Hybrid Cloud System and Table Configuration, Etc. Used in Hybrid Cloud System (FIG. 1-FIG. 10)

FIG. 1 is an example of a schematic diagram of a file storage service system employing a hybrid cloud in which a private cloud and public clouds exist. In other words, the hybrid cloud includes a plurality of clouds differing in availability, cost, performance, etc.

In the file storage service system, a client terminal 100, a management terminal 200, a gateway (computer) 300 and a private cloud 400 are connected together via a LAN 800. Further, the gateway 300 is connected to public clouds 500 via a WAN 900.

The client terminal 100 is a computer that is used by a user who uses the file storage service provided by the gateway 300. The management terminal 200 is a computer for managing the gateway 300, the private cloud 400 and the client terminal 100 via the LAN 800. The management terminal 200 is capable of acquiring management information on the public clouds 500 as needed.

The gateway 300 is a computer that provides the file storage service to the client terminal 100. Therefore, the gateway 300 performs file transfer among the client terminal 100, the private cloud 400 and the public clouds 500.

The private cloud 400 provides a file storage service (storing, readout, update, deletion, etc.) in response to instructions from the gateway 300.

Each public cloud 500 provides a file storage service (storing, update, deletion, etc.) via the WAN 900 in response to instructions from the gateway 300.

Terms “upload” and “download” will be used in this explanation in order to clarify the direction of file transfer. A file stream when the client terminal 100 stores a file in the private cloud 400 or a public cloud 500 will be referred to as “upload”. Thus, a file transfer stream from the client terminal 100 to the gateway 300 and a file transfer stream from the gateway 300 to the private cloud 400 or a public cloud 500 will be referred to as “upload”. In contrast, a file stream when the client terminal 100 acquires (reads out) a file stored in the private cloud 400 or a public cloud 500 will be referred to as “download” of a file. Thus, a file transfer stream from the gateway 300 to the client terminal 100 and a file transfer stream from the private cloud 400 or a public cloud 500 to the gateway 300 will be referred to as “download”.

A file ID for identifying each file is used for the file upload/download. The client terminal 100 attaches a file ID that is unique to the client terminal to each file. In this description, the file ID unique to the client terminal will be referred to as a “user file ID”. The gateway 300 attaches a file ID that is unique to the gateway to each file. In this description, the file ID unique to the gateway will be referred to as a “gateway file ID”.

First, a case where a file is uploaded from the client terminal 100 to a certain cloud will be explained below. The client terminal 100 attaches a user file ID to the file and transmits the file to the gateway 300. The gateway 300 attaches a gateway file ID to the received file and holds data indicating the correspondence among an identifier identifying the client terminal 100, the user file ID and the gateway file ID. The gateway 300 attaches the gateway file ID to the file and transmits the file to the cloud in which the file should be arranged (stored). The cloud holds data indicating the correspondence among an identifier identifying the gateway 300, the gateway file ID and path information indicating the storage position of the file. The above procedure of arranging a file in a cloud enables the client terminal 100 to download the uploaded file just by specifying the user file ID. Incidentally, file IDs transmitted from the client terminal 100 are user file IDs and file IDs used for processes executed by the gateway are gateway file IDs in this description unless otherwise noted.

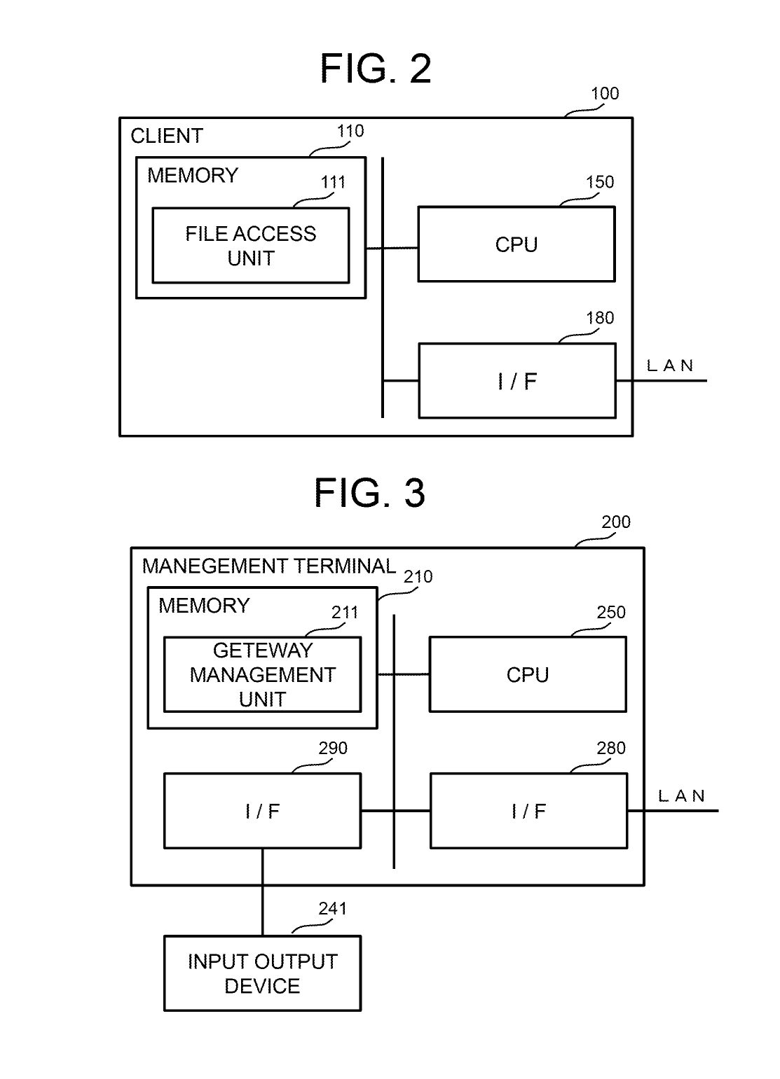

FIG. 2 is a block diagram showing the configuration of the client terminal 100. The client terminal 100 is a computer including a CPU 150, a memory 110, an I/F (interface) 180 for the connection to the LAN 800, and internal communication paths connecting these components together.

The CPU 150 executes processing units (programs) stored in the memory 110. The memory 110 stores the processing units (programs) and data. The processing units include a file access unit 111 which transmits/receives files to/from the gateway 300, for example.

FIG. 3 is a block diagram showing the configuration of the management terminal 200. The management terminal 200 (terminal for managing the gateway 300) is a computer including a CPU 250, a memory 210, an I/F 280 for the connection to the LAN 800, an input/output device 241 having a display screen, and internal communication paths connecting these components together.

The CPU 250 executes processing units (programs) stored in the memory 210. The memory 210 stores the processing units (programs) and data. The processing units include a gateway management unit 211, for example. Details of the gateway management unit 211 will be explained later.

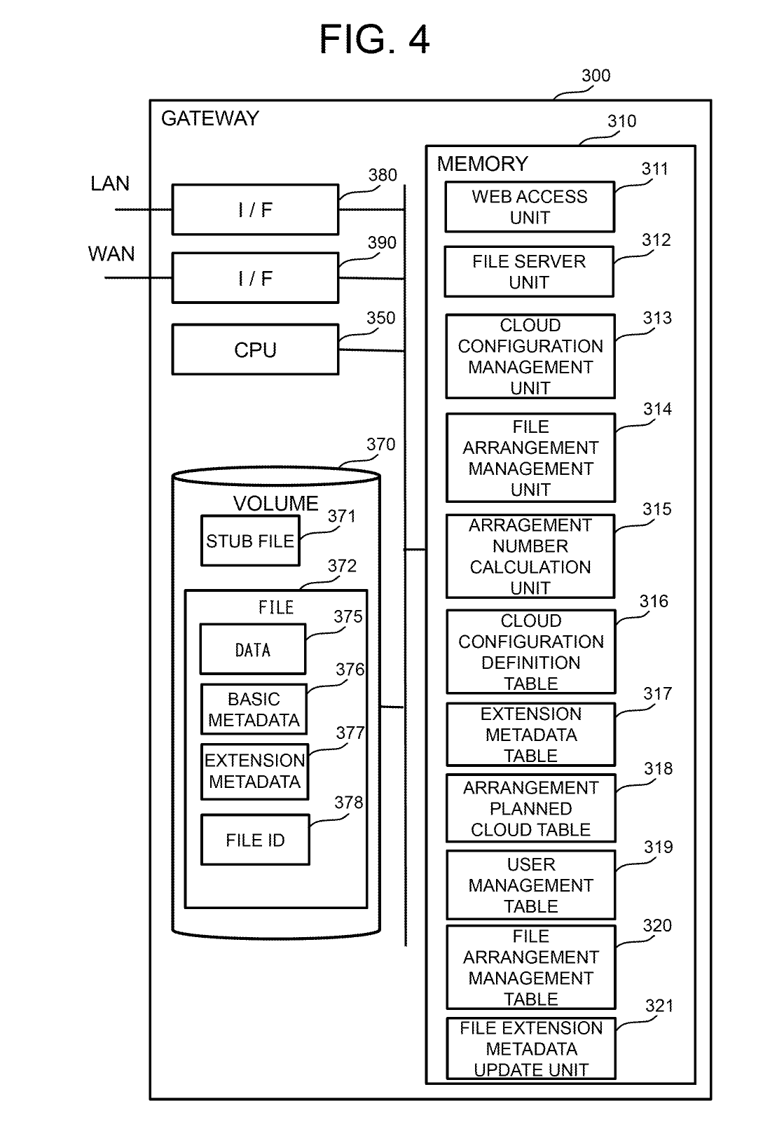

FIG. 4 is a block diagram showing the configuration of the gateway 300. The gateway 300 is a computer including a memory 310, a CPU 350, a storage device 370 (hereinafter referred to as a “volume 370”), an I/F 380 for the connection to the LAN 800, an I/F 390 for the connection to the WAN 900, and internal communication paths (e.g., bus) connecting these components together. The CPU 350 executes processing units (programs) stored in the memory 310. The processing units (programs) will be explained later.

The volume 370 stores a stub file 371 and a file 372. The stub file 371 stores data indicating the correspondence among a user name, a user file ID and a gateway file ID. The file 372 stores data 375 (entity of a file), basic metadata 376, extension metadata 377 and a file ID 378.

The basic metadata 376 represents metadata such as a user name (manager/creator of the file 372) and an ACL (Access Control List: list indicating access permission targets). Details of the extension metadata 377 will be explained later. The file ID 378 is an identifier for uniquely identifying the file 372 (i.e., the aforementioned gateway file ID).

The memory 310 stores processing units (programs) and tables for the file storage service. The processing units stored in the memory 310 include a web access unit 311, a file server unit 312, a cloud configuration management unit 313, a file arrangement management unit 314 and a duplication number calculation unit 315.

The web access unit 311 transmits/receives files to/from the private cloud 400 and the public clouds 500. The file server unit 312 provides a file server function to the client terminal 100. Specifically, the file server unit 312 allows the client terminal 100 to display the contents of the stub file 371, transmits/receives files to/from the client terminal 100, and so forth. The web access unit 311 and the file server unit 312 may also be implemented by using a web access program and a file server program already existing. Details of the other processing units will be explained later. The memory 310 further stores processing units unshown in FIG. 4 as will be explained later.

The tables include a cloud configuration definition table 316, an extension metadata table 317, an arrangement planned cloud table 318, a user management table 319 and a file arrangement management table 320. Further, the memory 310 has areas such as work areas necessary for the execution of the processing units.

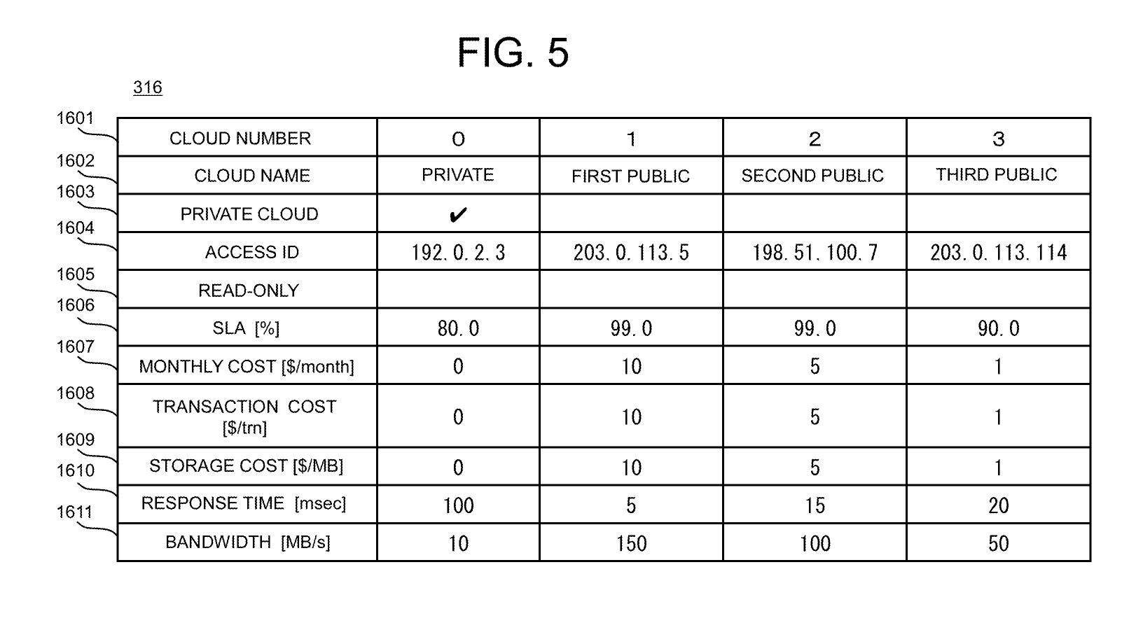

FIG. 5 shows an example of the cloud configuration definition table 316. The cloud configuration definition table 316 stores configuration information on the private cloud 400 and the public clouds 500 constituting the hybrid cloud which is used by the gateway 300 for the file storage service. The cloud configuration definition table 316 includes items such as cloud number 1601, cloud name 1602, private cloud 1603, access ID 1604, read-only 1605, SLA 1606, monthly cost 1607, transaction cost 1608, storage cost 1609, response time 1610 and bandwidth 1611.

The cloud number 1601 indicates an identifier uniquely identifying each cloud (private cloud 400, public cloud 500). The cloud name 1602 indicates the name of each cloud. The private cloud 1603 indicates whether each cloud is a private cloud or not. The access ID 1604 indicates path information (address) to be used by the web access unit 311 of the gateway 300 for accessing the private cloud 400 or a public cloud 500. The read-only 1605 indicates whether each cloud is a read-only cloud or not. The SLA 1606 indicates the SLA of each cloud (private cloud 400, public cloud 500).

The monthly cost 1607 indicates the usage fee of each cloud per month. The transaction cost 1608 indicates the usage fee of each cloud per transaction. The storage cost 1609 indicates the usage fee of each cloud per prescribed data capacity. The response time 1610 indicates a processing time necessary for the access to each cloud. The bandwidth 1611 indicates the maximum file transfer speed when a file is transferred between the gateway 300 and each cloud.

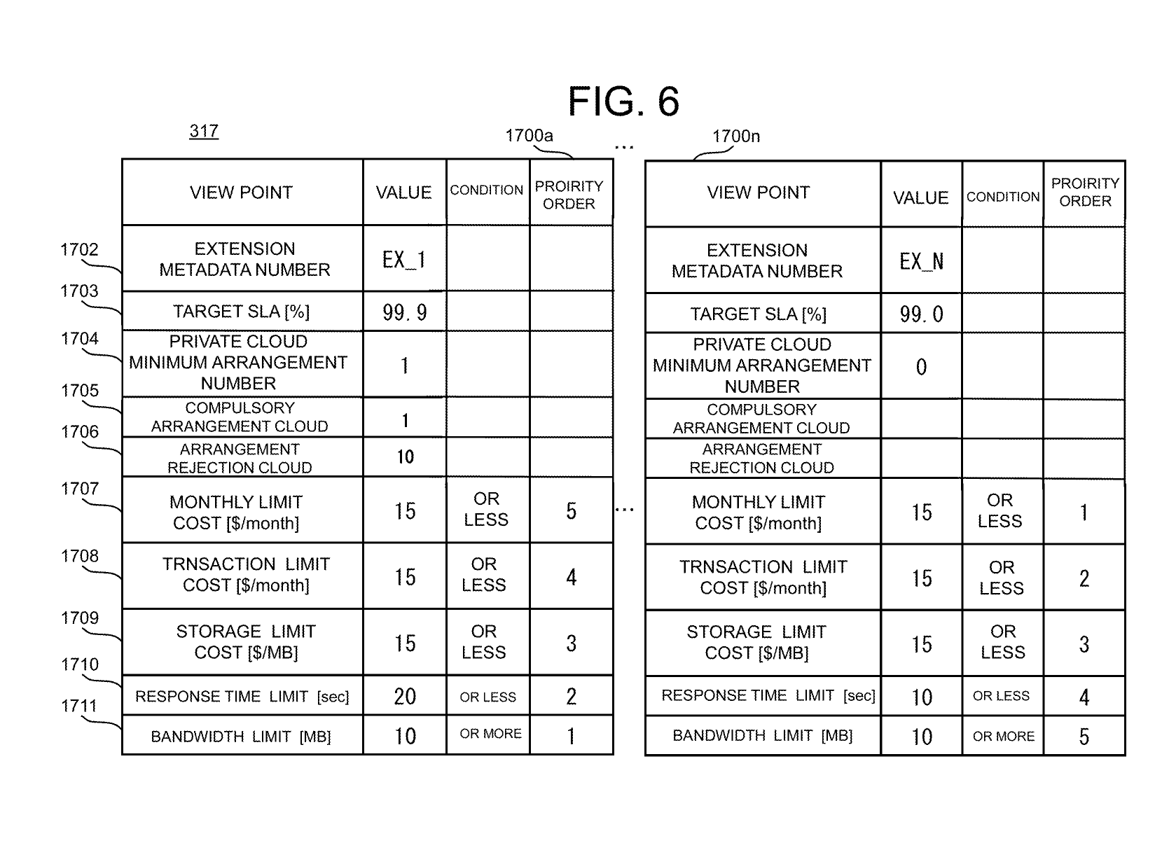

FIG. 6 shows an example of the extension metadata table 317. The extension metadata table 317 stores conditions to be used by the gateway 300 for selecting clouds in which a file should be arranged (stored). In the extension metadata table 317, the conditions for selecting clouds may be set for each user or for each viewpoint. In this case, the gateway 300 prepares each extension metadata table 317 (1700a-1700n) corresponding to each user or each viewpoint. The extension metadata table 317 includes items such as extension metadata table number 1702, target SLA 1703, private cloud minimum arrangement number 1704, compulsory arrangement cloud 1705, arrangement rejection cloud 1706, monthly limit cost 1707, transaction limit cost 1708, storage limit cost 1709, response time limit 1710 and bandwidth limit 1711.

Each item of the extension metadata table 317 has columns of value, condition and priority order. For example, the value and the condition in the monthly limit cost 1707 indicate that the monthly cost necessary for the file storage should be $15 or less. The priority order indicates the order of each item used for selecting clouds (1: top priority). Each of the monthly limit cost 1707, the transaction limit cost 1708, the storage limit cost 1709, the response time limit 1710 and the bandwidth limit 1711 (viewpoints 1701) has the value, the condition and the priority order, which are indices for preventing selection of a cloud not satisfying the conditions.

The extension metadata table number 1702 is an identifier for uniquely identifying each extension metadata table 1700a-1700n. The target SLA 1703 indicates SLA to be guaranteed when the gateway 300 arranges a file in clouds. Since the SLA is availability (availability factor) in this example, % is used as the unit of the target SLA.

The private cloud minimum arrangement number 1704 indicates the number of identical files that should be arranged in the private cloud 400. At least N (the number specified by the private cloud minimum arrangement number 1704) identical files (original file and/or duplicate files) are stored in the private cloud 400. The compulsory arrangement cloud 1705 indicates the cloud number of a cloud in which the file must be arranged. The arrangement rejection cloud 1706 stores (indicates) the cloud number of a cloud that is excluded from the clouds in which the file should be arranged (i.e., a cloud in which the file is not arranged).

The monthly limit cost 1707 indicates a condition regarding the monthly cost necessary for arranging files. The transaction limit cost 1708 indicates a condition regarding the transaction cost necessary for accessing a file arranged in a cloud. The storage limit cost 1709 indicates a condition regarding the storage cost (per unit capacity) necessary for arranging files.

The response time limit 1710 indicates a condition regarding the response time in making access to an arranged file. The bandwidth limit 1711 indicates a condition regarding the file transfer speed (bandwidth) in the arrangement (storing) or the readout of a file.

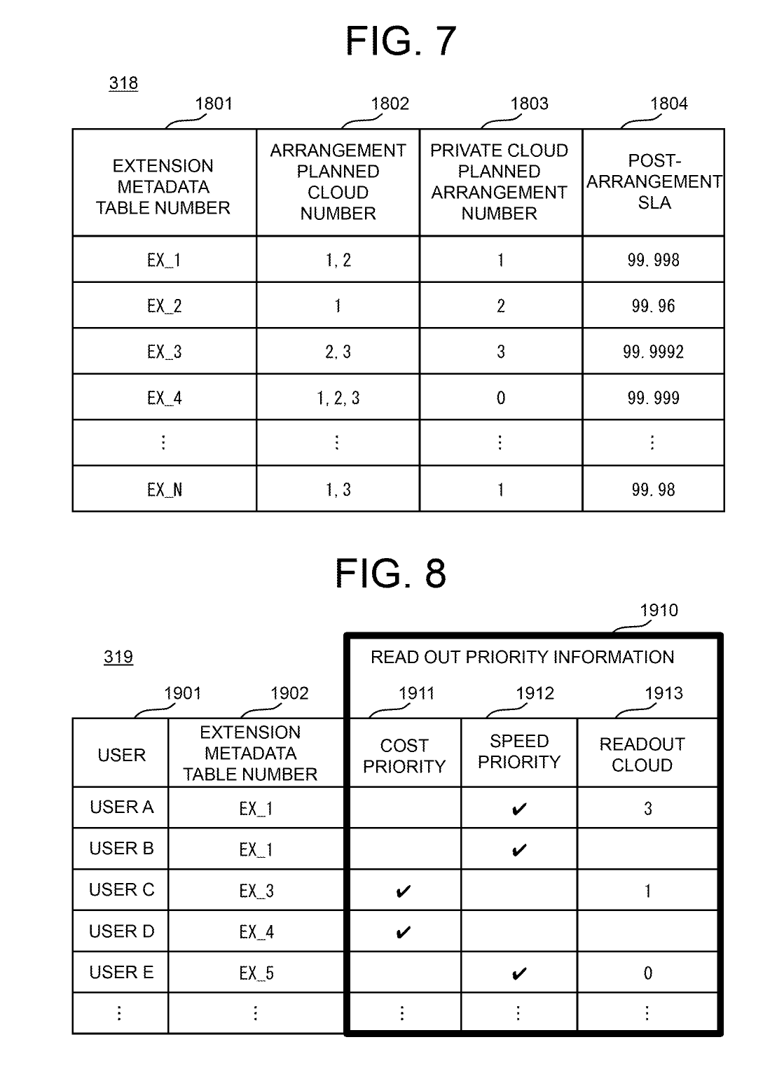

FIG. 7 shows an example of the arrangement planned cloud table 318. The arrangement planned cloud table 318 stores the result of determining the clouds (in which a file should be arranged) under the conditions indicated by each extension metadata table 317. The arrangement planned cloud table 318 includes items such as extension metadata table number 1801, arrangement planned cloud number 1802, private cloud planned arrangement number 1803 and post-arrangement SLA 1804.

The arrangement planned cloud number 1802 stores (indicates) a list of cloud numbers of public clouds 500 in which a file should be arranged. The private cloud planned arrangement number 1803 indicates the number of files (identical with a file stored in a public cloud 500) that should be arranged in the private cloud 400. The post-arrangement SLA 1804 indicates the value of the SLA (availability factor) guaranteeing the arranged (saved) files determined from the SLA of the clouds in which the file is arranged (indicated by the arrangement planned cloud number 1802) and the SLA of the private cloud 400 in which m files (m: the number indicated by the private cloud planned arrangement number 1803) are arranged.

FIG. 8 shows an example of the user management table 319. The user management table 319 stores extension metadata table numbers 1902 used by users 1901 and readout priority information 1910. The readout priority information 1910 indicates each prioritized acquisition method to be used when each user 1901 acquires a file (which seems to have been stored in the gateway 300 when viewed from the client terminal 100) from a cloud.

The user 1901 stores (indicates) each identifier uniquely identifying each user who uses the client terminal 100 for uploading/downloading a file to/from the gateway 300. The extension metadata table number 1902 indicates an extension metadata table number corresponding to each user 1901.

The readout priority information 1910 includes cost priority 1911, speed priority 1912 and readout cloud 1913, each indicating a method (check mark) to be prioritized when the gateway 300 acquires (downloads) a file from a cloud. The cost priority 1911 means that the gateway 300 selects a low-cost cloud (from which the file can be acquired at a low cost) from the clouds storing the identical files. The speed priority 1912 means that the gateway 300 selects a high-speed cloud (from which the file can be acquired at high speed (in a short time)) from the clouds storing the identical files. The readout cloud 1913 specifies the cloud number of a cloud from which the file should be read out (used when the cloud as the target of file readout is fixed irrespective of the cost priority 1911 or the speed priority 1912).

Incidentally, while the user management table 319 of FIG. 8 indicates an extension metadata table number 1902 for (corresponding to) each user, it is possible to assign the same extension metadata table number (EX_{—}1) to different users as shown in FIG. 8.

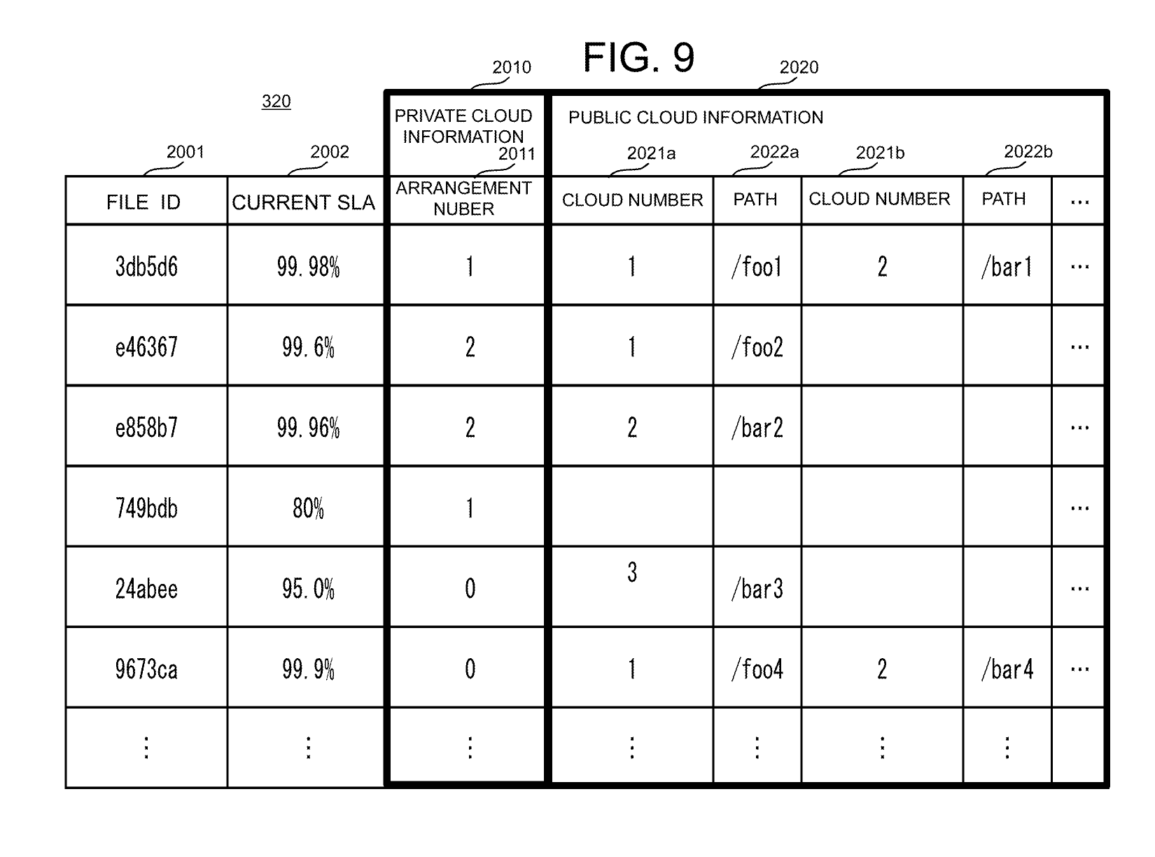

FIG. 9 shows an example of the file arrangement management table 320. The file arrangement management table 320 includes items such as file ID 2001, current SLA 2002, private cloud information 2010 and public cloud information 2020.

The file ID 2001 indicates each gateway file ID uniquely identifying each file stored in clouds. The current SLA 2002 indicates SLA that is determined from the SLA of the public clouds (in which the file represented by the file ID 2001 has been arranged) and the arrangement number of the private cloud.

The private cloud information 2010 indicates the number of files represented by the file ID 2001 that have been arranged in the private cloud 400 (arrangement number 2011). The public cloud information 2020 indicates a combination (pair) of a cloud number 2021 of a public cloud 500 and a path 2022 for accessing a file stored in the public cloud 500. In cases where the file represented by the file ID 2001 has been arranged in a plurality of (M) public clouds 500, there are M pairs of cloud number 2021 and path 2022. The path 2022 indicates path information (address) of the public cloud 500 in which the file has been arranged. The path 2022 is used when the web access unit 311 makes access to the public cloud 500.

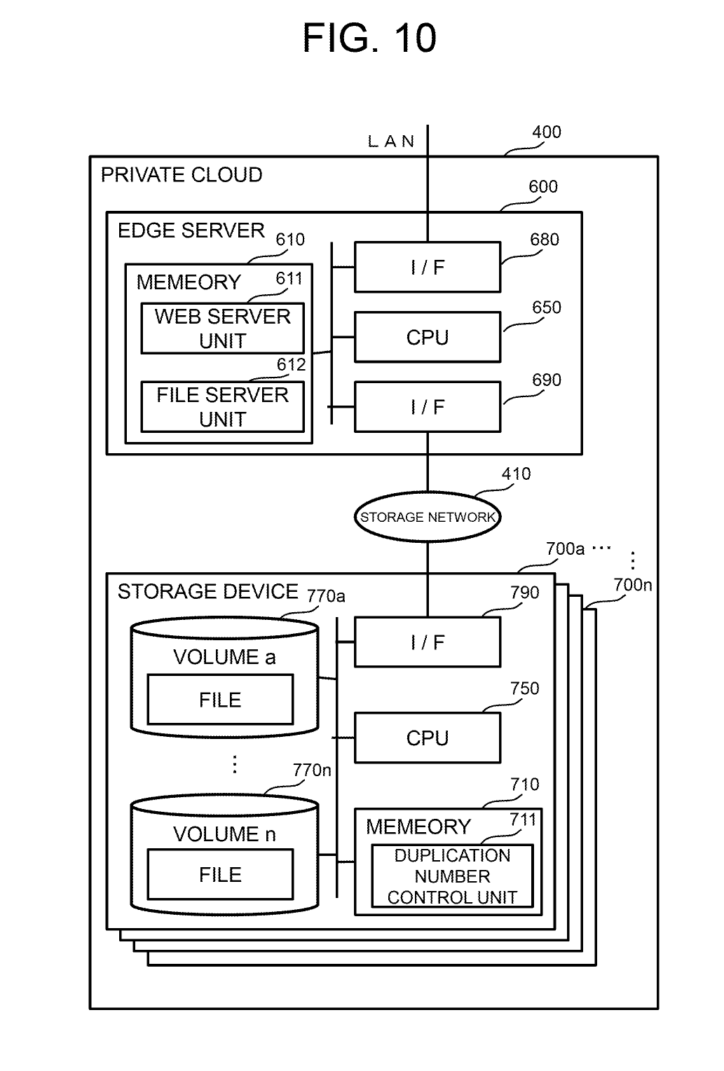

FIG. 10 is a block diagram showing the configuration of the private cloud (storage) 400. The private cloud 400 includes an edge server 600 for the connection to the LAN 800, storage devices 700, and a storage network 410 connecting these components together.

The edge server 600 is a computer including a CPU 650, a memory 610, an I/F 680 for the connection to the LAN 800, an I/F 690 for the connection to the storage network, and internal communication paths (e.g., bus) connecting these components together. The memory 610 stores processing units (programs) and data. A web server unit 611 and a file server unit 612 are stored in the memory 610. The web server unit 611 carries out file transfer between the private cloud 400 and the gateway 300. The file server unit 612 carries out file transfer between the edge server 600 and the storage devices 700. Since each file is transferred to the private cloud 400 together with the file identifier (ID) unique to the gateway 300 as mentioned above, the edge server 600 has a correspondence table indicating the correspondence between the file identifier unique to the gateway 300 and the file identifier unique to the private cloud 400 and the web server unit 611 carries out the file operation (storing, readout) inside the private cloud 400 by referring to the correspondence table.

Each storage device 700 is a computer including a CPU 750, a memory 710, n volumes 770, an I/F 790 for the connection to the internal network, and internal communication paths (e.g., bus) connecting these components together. The volumes 770 store files. The memory 710 stores processing units (programs) and data. A duplication number control unit 711 is stored in the memory 710. The duplication number control unit 711 arranges each file according to the arrangement number specified by the gateway 300. The duplication number control unit 711 is unnecessary in a mode in which the gateway 300 transfers a plurality of identical files corresponding to the arrangement number to the private cloud 400. A file may be arranged to straddle two or more of the volumes 770a-770n or storage devices 700a-700n. The storage network 410 is a LAN (Local Area Network) or a SAN (Storage Area Network), for example.

The configuration of each public cloud 500 (illustration thereof is omitted here) is substantially equivalent to that of the private cloud 400 shown in FIG. 10. The difference from the private cloud 400 includes the carrier operating the cloud, the SLA and the various types of costs shown in the cloud configuration definition table 316 of FIG. 5, performance, etc. as mentioned above.

(2) Process for Arranging Files in Hybrid Cloud System (FIG. 11)

When the user A has uploaded a file from the client terminal 100 to the gateway 300, the file server unit 312 of the gateway 300 stores the received file in the volume 370 as the data 375 (entity of the received file) of the file 372. The file server unit 312 stores basic metadata (received together with the file and including “user A” as the user name) in the basic metadata 376. The user name may also be identified based on the source address (transmission address) at the time of receiving the file from the client terminal 100. The file server unit 312 further converts the client terminal user file ID attached to the received file into a gateway file ID, stores the correspondence between the client terminal user file ID and the gateway file ID in the stub file 371, and stores the gateway file ID in the file ID 378 of the volume 370. The file server unit 312 activates the file arrangement management unit 314.

FIG. 11 is an example of a processing flow chart of the file arrangement management unit 314 of the gateway 300. The file arrangement management unit 314 acquires the user name (of the user who uploaded the file) stored in the basic metadata 376 (S2401). The user name is assumed to be “user A” in this example.

The file arrangement management unit 314 refers to the user management table 319 (FIG. 8) and thereby acquires the extension metadata table number 1902 (EX 1) of the user A stored in the user 1901 (S2402). The file arrangement management unit 314 acquires the extension metadata table 317 having the acquired extension metadata table number EX_{—}1 (extension metadata table 1700a in this example) and stores the acquired extension metadata table 317 in the extension metadata 377 of the file 372 in order to associate it with the file received by the file server 312 (S2403).

The file arrangement management unit 314 refers to the arrangement planned cloud table 318 and thereby acquires the arrangement planned cloud number 1802 (“1”, “2” in FIG. 7) and the private cloud planned arrangement number 1803 (“1” in FIG. 7) corresponding to the extension metadata table number EX_{—}1 stored in the extension metadata 377 (S2404).

The file arrangement management unit 314 reserves a new entry (line) in the file arrangement management table 320, stores the gateway file ID (stored in the file ID 378 of the file 372) as the file ID 2001 of the new entry (line), and stores the contents “1” of the private cloud planned arrangement number 1803 in the arrangement number 2011 of the private cloud information 2010. The data “1” and “2” in the arrangement planned cloud number 1802 are respectively stored in the cloud numbers 2021a and 2021b of the public cloud information 2020 of the new entry (S2405). The path information 2022a and 2022b corresponding to the cloud numbers 2021a and 2021b is stored by referring to a correspondence table between the cloud numbers and the path information which has been prepared separately.

The file arrangement management unit 314 activates the web access unit 311 while specifying the gateway file ID stored in the file ID 2001 of the new entry of the file arrangement management table 320 (S2406). The web access unit 311 transmits/arranges the data 375 of the file corresponding to the specified file ID to/in the private cloud 400 according to the number specified in the arrangement number 2011 of the file arrangement management table 320 and transmits/arranges the path information 2022a and 2022b specified in the public cloud information 2020 of the file arrangement management table 320 to/in the public clouds 500 having the cloud numbers 2021a and 2021b as addresses. In cases where the private cloud 400 arranges duplication files (duplications of a file) according to the arrangement number (i.e., in cases where the duplication number control unit 711 shown in FIG. 10 has been prepared), file transmission performed by the web access unit 311 only once is enough for the file arrangement in the private cloud 400.

In order to inform the user A of the completion of the upload, the file arrangement management unit 314 refers to the stub file 371 and transmits the user file ID corresponding to the gateway file ID of the file arranged in the hybrid cloud to the client terminal 100 (S2407).

As above, the clouds in which the file should be arranged are selected based on the extension metadata associated with the user (i.e., contents of the extension metadata table 317). Therefore, by previously setting (specifying) public clouds 500 for substituting for the private cloud 400 in the arrangement planned cloud table 318 and the user management table 319 as the extension metadata table number, the clouds in which the file should be arranged can be selected with ease based on the setting. The setting in the arrangement planned cloud table 318 and the user management table 319 will be explained later.

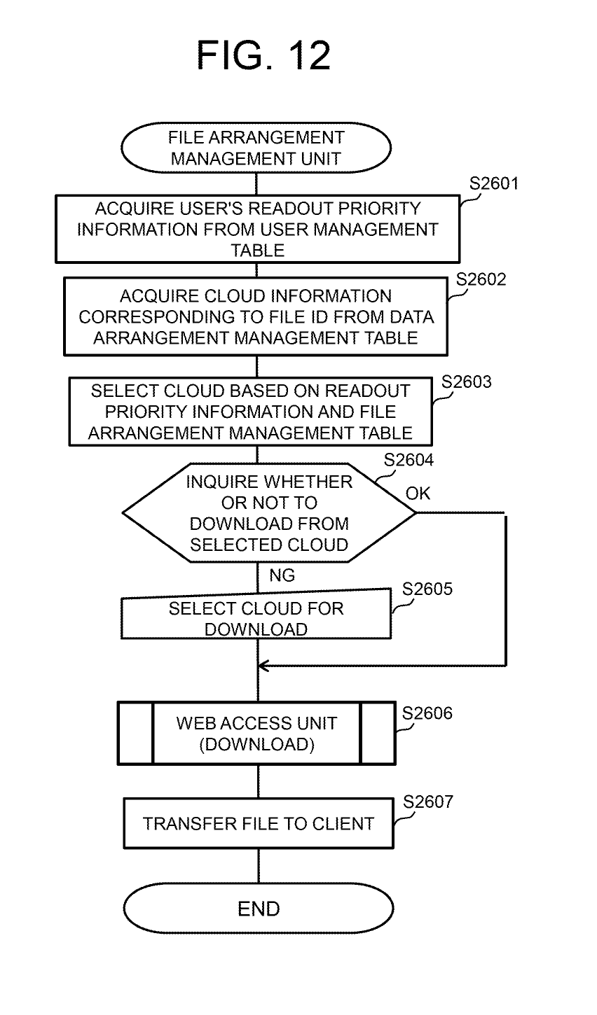

(3) Process for Reading Out File from Hybrid Cloud System (FIG. 12)

When the user A transmits a user file ID from the client terminal 100 in order to download a file from the gateway 300, the file server unit 312 converts the user file ID into the gateway file ID by referring to the file ID correspondence table in the stub file 371 and stores the acquired gateway file ID in the file ID 378 of the volume 370. In this example, the file ID stored in the file ID 378 is assumed to be “3db5d6”. The file server unit 312 identifies the user name by referring to the stub file 371 and stores the acquired user name in the basic metadata 376. The file server unit 312 activates the file arrangement management unit 314.

FIG. 12 is an example of a processing flow chart of the file arrangement management unit 314 of the gateway 300. The file arrangement management unit 314 refers to the user management table 319 and thereby acquires the readout priority information 1910 corresponding to the user name included in the basic metadata 376 (S2601). In the example of FIG. 8, the user A reads out the intended file preferentially from the public cloud 500 having the cloud number “3”. If the intended file does not exist in the public cloud 500 having the cloud number “3” and a plurality of the same intended files have been arranged in public clouds 500 having cloud numbers other than “3”, one of the intended files arranged in the private cloud 400 and the public clouds 500 having cloud numbers other than “3” is acquired by the speed priority method.

The file arrangement management unit 314 acquires the cloud information (i.e., the private cloud information 2010 and the public cloud information 2020) corresponding to the file ID 2001 “3db5d6” by referring to the file arrangement management table 320 (52602). In this example, the arrangement number “1” as the private cloud information 2010 and the cloud numbers “1” and “2” as the public cloud information 2020 are acquired.

The file arrangement management unit 314 selects a cloud as the target of reading out the file having the file ID “3db5d6” based on the readout priority information and the cloud information (S2603). The cloud having the cloud number already set in the readout cloud 1913 of the user management table 319 is selected as the target of the file readout. However, when the file has not been arranged in the cloud having the cloud number already set in the readout cloud 1913 and when no cloud number has been set in the readout cloud 1913, the readout cloud is selected by the speed priority method or the cost priority method. In the case of the cost priority method, a cloud with the lowest transaction cost is selected by referring to the cloud configuration definition table 316. When the speed priority method is specified in the readout priority information 1910, a cloud with the greatest bandwidth 1611 is selected by referring to the cloud configuration definition table 316. In this example, the readout cloud is selected by the speed priority method since the intended file (i.e., the file having the file ID “3db5d6” in the file ID 2001 of the file arrangement management table 320) has not been arranged in the cloud having the cloud number “3” even though the cloud number “3” has been specified in the readout cloud 1913. In this case, the cloud with the cloud number “1” and the cloud with the cloud number “2” are compared with each other by referring to the cloud configuration definition table 316 and the cloud with the cloud number “1” having the greater bandwidth is selected.

The file arrangement management unit 314 inquires of the user A whether or not to acquire the file (whose the file ID 2001 is “3db5d6”) from the cloud (having the cloud number “1”) selected in the step S2603 (S2604). In the inquiry of the user A, the file arrangement management unit 314 transmits the cloud information on the clouds in which the file has been arranged (the private cloud information 2010 and the public cloud information 2020) to the client terminal 100 while associating the cloud information with the file ID 2001 “3db5d6” in the file arrangement management table 320. Based on the received cloud information, the user A selects the cloud selected in the step S2603 (OK) or a cloud having another cloud number included in the received cloud information (NG) (S2605). If NG, the user A transmits the selected cloud number from the client terminal 100. When the inquiry of the user A is unnecessary, the steps S2604 and S2605 are omitted.

The file arrangement management unit 314 sends a file download request to the web access unit 311 while specifying the gateway file ID (3db5d6) of the file to be downloaded and the selected cloud number (S2606). The web access unit 311 stores the downloaded file in the data 375 of the file 372 of the volume 370. The file arrangement management unit 314 transfers the file, which has been downloaded and stored in the data 375, to the client terminal 100 (S2607).

While the above explanation has been given by illustrating the process of the file arrangement management unit 314 for the file download in FIG. 12 and the process of the file arrangement management unit 314 for the file upload in FIG. 11, the processes for the file download and the file upload may be carried out differently. For example, the file server unit 312 receiving the file or the user file ID may activate the file arrangement management unit 314 while specifying upload or download and the activated file arrangement management unit 314 may branch to the process of FIG. 11 or the process of FIG. 12 according to the specification of upload or download.

As above, the cloud from which the file should be downloaded is selected based on the settings in the cloud configuration definition table 316 and the user management table 319. Therefore, a cloud minimizing the downloading cost or maximizing the downloading speed can be selected.

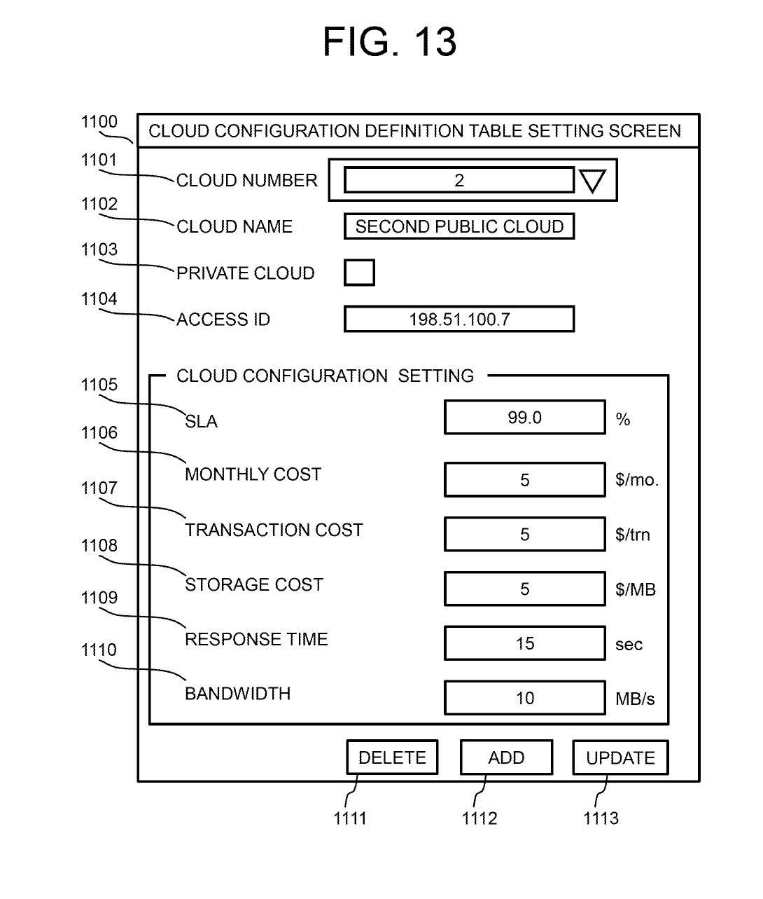

(4) Process Executed in Response to Configuration Change of Public Cloud Constituting Hybrid Cloud System (FIG. 13-FIG. 15)

FIG. 13 shows an example of a cloud configuration definition table setting screen 1100. In this example, the cloud configuration definition table 316 stored in the memory 310 of the gateway 300 is edited by receiving inputs from the manager of the system through the management terminal 200. The cloud configuration definition table setting screen 1100 displays the following items and receives inputs (e.g., alteration of the contents of an item) from the manager. Corresponding to the items of the cloud configuration definition table 316, the cloud configuration definition table setting screen 1100 displays items such as cloud number 1101, cloud name 1102, private cloud 1103, access ID 1104 and cloud configuration settings. The cloud configuration settings include SLA 1105, monthly cost 1106, transaction cost 1107, storage cost 1108, response time 1109 and bandwidth 1110. The cloud configuration definition table setting screen 1100 further includes a deletion button 1111 to be pressed for inputting an instruction for deleting the clouds displayed in the cloud number 1101 and the cloud name 1102, an addition button 1112 to be pressed for inputting an instruction for adding new data, and an update button 1113 to be pressed for inputting an update instruction. The cloud configuration management unit 313 is activated in response to the instruction input through each button.

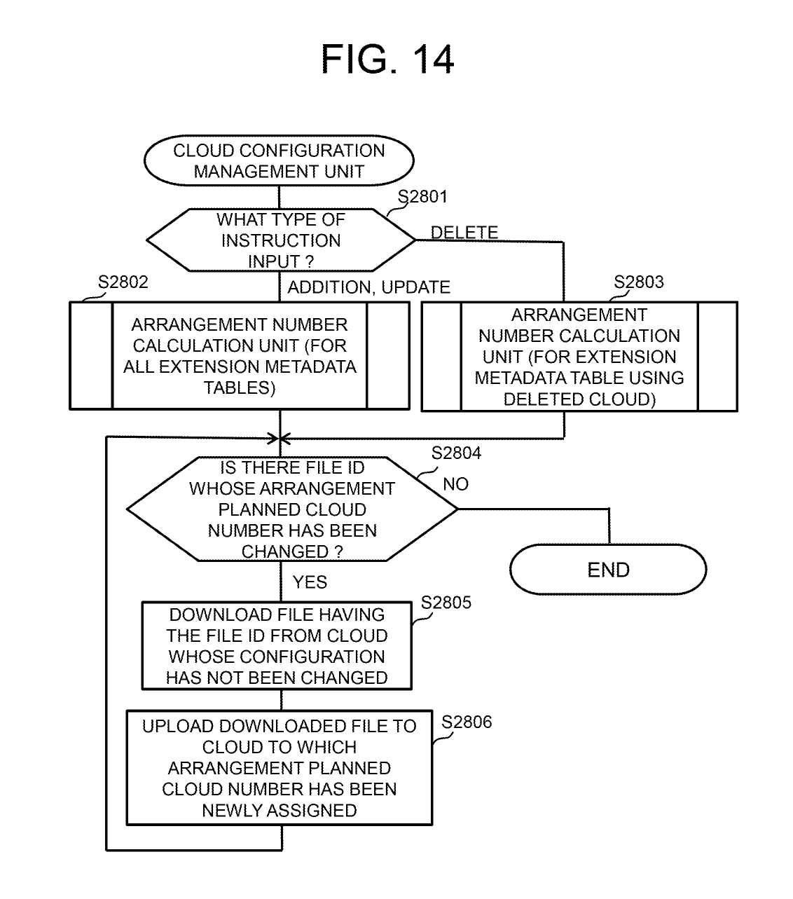

FIG. 14 is an example of a processing flow chart of the cloud configuration management unit 313. The cloud configuration management unit 313 judges the type of the instruction input (S2801) and advances to step S2802 when the instruction input was through the addition button 1112 or the update button 1113. When the instruction input was through the deletion button 1111, the process advances to step S2803.

In the case of an instruction input through the addition button 1112 or the update button 1113, the cloud configuration management unit 313 activates the arrangement number calculation unit 315 while specifying each extension metadata table 317 (S2802). The arrangement planned cloud table 318 is updated by a process (explained later) executed by the arrangement number calculation unit 315.

For example, when the bandwidth of the second public cloud (with the cloud number “2”) in the cloud configuration definition table 316 has been changed from 100 MB/sec to 10 MB/sec, the arrangement planned cloud number 1802 of the extension metadata table number EX_{—}1 in the arrangement planned cloud table 318 is updated from “1”, “2” to “1”, “3” since the bandwidth of the third public cloud (50 MB/sec) is wider (higher speed) than that of the second public cloud (although the bandwidth limit 1711 in the extension metadata table 317 having the extension metadata table number EX_{—}1 is 10 MB/sec or more). The arrangement planned cloud number “2” which is disused due to the update is stored in a work area.

On the other hand, in the case of an instruction input through the deletion button 1111, the cloud configuration management unit 313 activates the arrangement number calculation unit 315 while referring to the arrangement planned cloud table 318 and specifying the extension metadata table number 1801 of each extension metadata table using the cloud having the deleted cloud number (S2803). The arrangement planned cloud table is updated by a process (explained later) executed by the arrangement number calculation unit 315.

For example, when the first public cloud having the cloud number “1” has been deleted, the arrangement planned cloud number 1802 for the extension metadata table number EX_{—}1 in the arrangement planned cloud table 318 is updated from “1”, “2” to “2”, “3”. The arrangement planned cloud number “1” which is disused due to the update is stored in the work area.

The step 2802 (in the case of the instruction input through the addition button 1112 or the update button 1113) differs from the step 2803 (in the case of the instruction input through the deletion button 1111) in that the step 2802 executes the arrangement number calculation unit 315 for all the extension metadata tables 317 whereas the step 2803 executes the arrangement number calculation unit 315 only for extension metadata tables 317 using the cloud having the deleted cloud number.

The cloud configuration management unit 313 judges whether or not the file arrangement management table 320 includes a file ID 2001 whose public cloud information 2020 includes an arrangement planned cloud number stored in the work area (S2804). When such a file ID 2001 does not exist in the file arrangement management table 320 (NO: no change in the arrangement planned clouds), the process is ended. When such a file ID 2001 exists (YES), the file is rearranged by repeating the steps S2805 and S2806. For example, in a case where the arrangement planned cloud number “1” was stored in the work area in the step S2803, the cloud configuration management unit 313 judges that there exists a file ID 2001 “3db5d6” that had been using the arrangement planned cloud number “1”.

The cloud configuration management unit 313 activates the web access unit 311 and thereby downloads an identical file (having the file ID of the file that had been arranged in the arrangement planned cloud disused due to the update) from a cloud whose configuration has not been changed (S2805). The destination of the download is the file 372 in the volume 370. The entity of the file is stored in the data 375. Further, the file ID of the downloaded file is stored in the file ID 378. In the above example of the step S2803, for example, the file whose file ID 2001 is “3db5d6” has disused the cloud having the arrangement planned cloud number “1”, and thus the cloud configuration management unit 313 refers to the file arrangement management table 320 and downloads the identical file from the cloud having the arrangement planned cloud number “2” whose configuration has not been changed.

The cloud configuration management unit 313 activates the web access unit 311 and thereby uploads the downloaded file (stored in the file 372) to the cloud to which an arrangement planned cloud number has been newly assigned (S2806). In the above example of the step S2803, for example, the cloud configuration management unit 313 refers to the file arrangement management table 320 and uploads the downloaded file to the cloud having the newly assigned arrangement planned cloud number “3”. By repeating the above steps S2805 and S2806, files can be rearranged properly in response to the change in the cloud configuration.

Incidentally, the file that has been arranged in the arrangement planned cloud disused due to the update is deleted as needed by activating the web access unit 311.

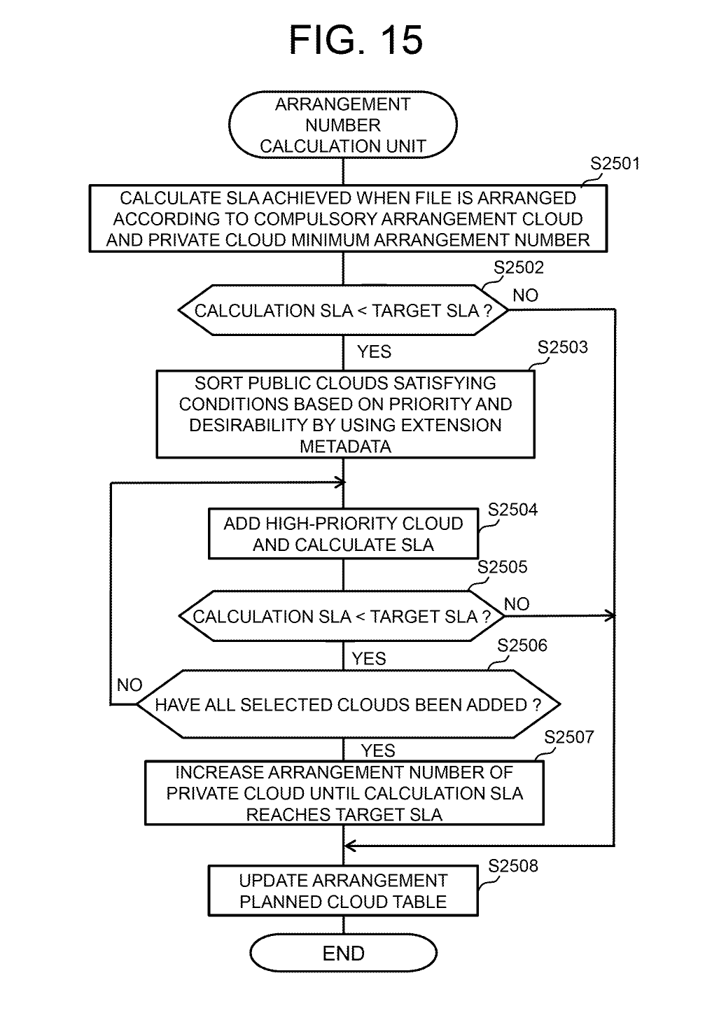

FIG. 15 is an example of a processing flow chart of the arrangement number calculation unit 315. An explanation of the processing by the arrangement number calculation unit 315 will be given below by using the above example of the step S2802 of the cloud configuration management unit 313 in which the bandwidth of the second public cloud having the cloud number “2” has been changed from 100 MB/sec to 10 MB/sec.

The arrangement number calculation unit 315 acquires the SLA of the cloud corresponding to the cloud number stored in the compulsory arrangement cloud 1705 of the extension metadata table 317 specified by the file arrangement management unit 314 from the cloud configuration definition table 316, acquires the private cloud minimum arrangement number 1704 of the extension metadata table 317, acquires the SLA of the private cloud from the cloud configuration definition table 316, and determines combined SLA by combining SLA corresponding to the arrangement number of the private cloud and SLA of the compulsory arrangement cloud (S2501). The combined SLA will hereinafter be referred to as “calculation SLA”. Since the clouds can be considered to be in parallel connection, the calculation SLA can be determined as:

(calculation SLA)=1−Π(1−αᵢ)

where αᵢ (i=1, 2, . . . , n) represents the SLA (availability factor) of the i-th cloud.

The arrangement number calculation unit 315 compares the calculation SLA determined above with the target SLA 1703 in the specified extension metadata table (S2502). When the calculation SLA is the target SLA 1703 or greater, the process advances to step S2508. When the calculation SLA is less than the target SLA, the process advances to step S2503.

The arrangement number calculation unit 315 selects public clouds satisfying the various conditions 1707-1711 in the specified extension metadata table 317 from the cloud configuration definition table 316 and sorts the selected public clouds in descending order of desirability (degree of fulfillment of the conditions) by using the priority order in the extension metadata table 317 (92503).

For example, when there are a plurality of clouds satisfying the various conditions 1707-1711 in the extension metadata table 317 shown in FIG. 6 and the bandwidths 1611 of the plurality of public clouds 500 (corresponding to the bandwidth limit 1711 whose priority order is “1”) are equal to one another, the sorting is carried out so as to place a public cloud 500 having a shorter response time 1610 (corresponding to the response time limit 1710 whose priority order is “2”) at a more upper position.

The arrangement number calculation unit 315 selects high-ranking public clouds 500 from the sorted public clouds 500 and determines the calculation SLA (S2504). The method of determining the calculation SLA in this step is equivalent to the method explained above.

The arrangement number calculation unit 315 compares the calculation SLA determined above with the target SLA in the extension metadata table 317 (S2505). When the calculation SLA is the target SLA or greater, the process advances to the step S2508. When the calculation SLA is less than the target SLA, the process advances to step S2506.

In the case where the calculation SLA is less than the target SLA, the arrangement number calculation unit 315 judges whether all the public clouds 500 selected and sorted in the step S2503 have been added or not (S2506). When all such public clouds 500 have already been added, the process advances to step S2507, otherwise the process advances to the step S2504.

When the calculation SLA remains less than the target SLA even after adding all the public clouds 500 selected in the step S2503, the arrangement number of the private cloud 400 is increased. Upon each increment of the arrangement number of the private cloud 400 by 1, the calculation SLA including the SLA of the private cloud 400 is determined. The arrangement number of the private cloud 400 is increased until the calculation SLA becomes the target SLA or greater (S2507).

The arrangement planned cloud number 1802 and the private cloud planned arrangement number 1803 at the stage of determining the calculation SLA greater than or equal to the target SLA 1703 in the extension metadata table 317 (S2502, S2504 or S2507) are updated while associating them with the extension metadata table number 1801 in the arrangement planned cloud table 318 (the table number of the extension metadata table 317 specified by the file arrangement management unit 314) (S2508).

As explained above, when a setting in the cloud configuration definition table 316 has been changed, the clouds in which the file should be arranged are selected again based on the performance indices (various conditions in the extension metadata table 317). Therefore, clouds minimizing the downloading cost or maximizing the downloading speed can be selected while satisfying the SLA. Incidentally, while the arrangement number of the private cloud is increased in this embodiment when the target SLA is not satisfied even by adding public clouds, the method of the rearrangement is not restricted to this example. For example, it is possible to calculate an appropriate arrangement in private/public clouds so that the cost is minimized among arrangements satisfying the SLA.

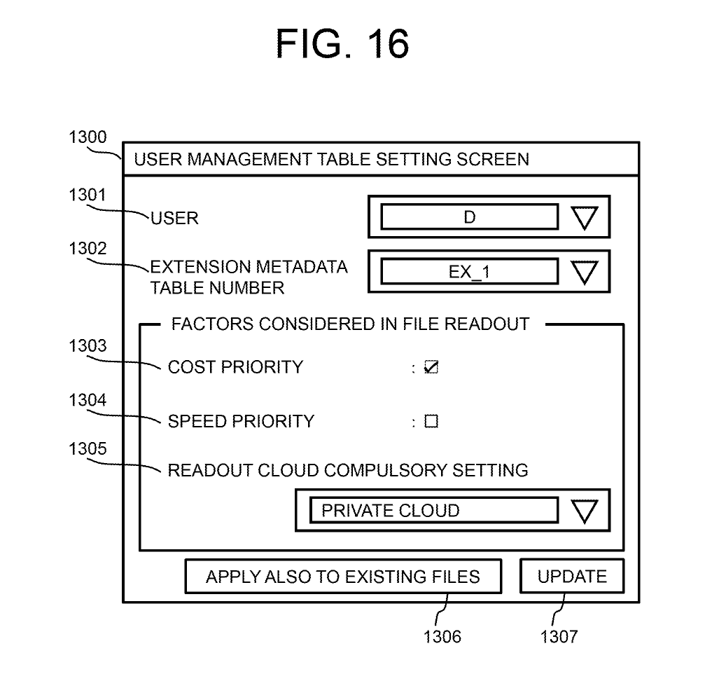

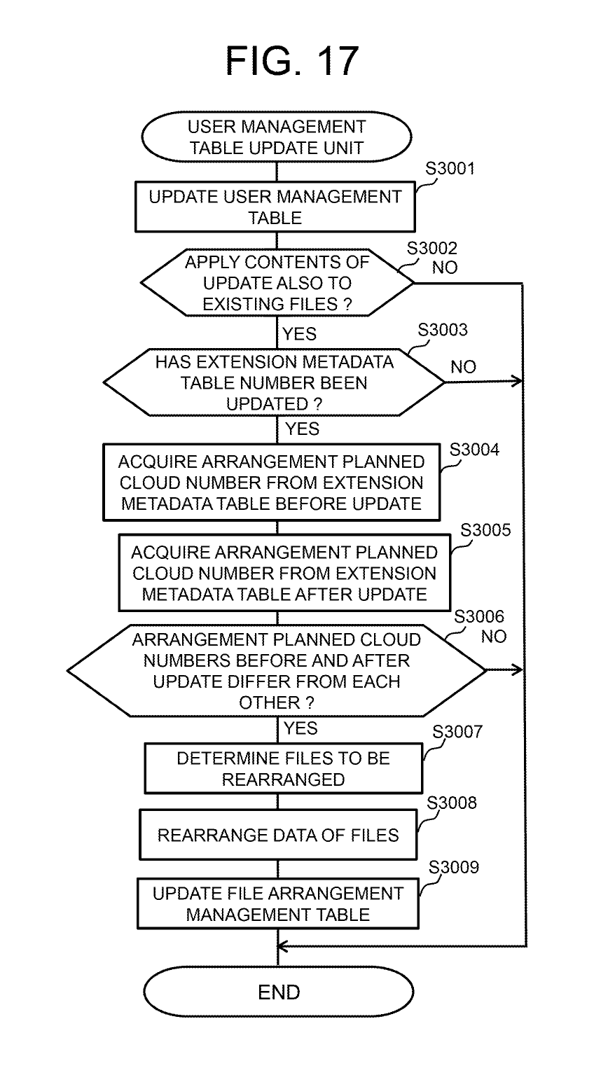

(5) Process Executed in Response to Change in File Arrangement Specification (FIG. 16, FIG. 17)

A process executed when the user management table 319 has been updated through the management terminal 200 for changing a file arrangement specification will be explained below.

FIG. 16 shows an example of a user management table setting screen 1300 of the management terminal 200. The user management table setting screen 1300 displays the following items corresponding to the items of the user management table 319 and receives inputs (e.g., alteration of the contents of an item) from the manager. The user management table setting screen 1300 displays items such as user name 1301, extension metadata table number 1302, cost priority 1303, speed priority 1304 and readout cloud compulsory setting 1305. The cost priority 1303, the speed priority 1304 and the readout cloud compulsory setting 1305 are factors to be considered in file readout. The user management table setting screen 1300 further includes an “APPLY ALSO TO EXISTING FILES” button 1306 and an update button 1307. The “APPLY ALSO TO EXISTING FILES” button 1306 is pressed for inputting an instruction for applying the settings made on the user management table setting screen 1300 also to existing files (files already arranged in the hybrid cloud). The update button 1307 is pressed for inputting an instruction for just updating the user management table 319. A user management table update unit (not shown in FIG. 4) is activated in response to the instruction input through each button.

FIG. 17 is an example of a processing flow chart of the user management table update unit. In response to the instruction input through the user management table setting screen 1300, the user management table 319 is updated according to the settings in the user management table setting screen 1300 (S3001). When the extension metadata table number has been updated, the extension metadata table number before the update is stored in the work area. Whether the instruction input applies also to the existing files or not is judged (S3002). If applies, the process advances to step S3003, otherwise the process ends. Whether the extension metadata table number 1902 in the user management table 319 has been updated or not is judged (S3003). If updated, the process advances to step S3004, otherwise the process ends.

The arrangement planned cloud number 1802 corresponding to the extension metadata table number before the update stored in the work area is acquired by referring to the arrangement planned cloud table 318 (S3004). Subsequently, the arrangement planned cloud number 1802 corresponding to the extension metadata table number after the update is acquired by referring to the arrangement planned cloud table 318 (S3005). Whether the arrangement planned cloud numbers 1802 before and after the update are different from each other or not is judged (S3006). If different, the process advances to step S3007, otherwise the process ends. Arrangement planned cloud numbers identical before and after the update, arrangement planned cloud numbers used before the update and not used after the update, and arrangement planned cloud numbers not used before the update and used after the update are determined (identified) as the difference between the arrangement planned cloud numbers 1802 before and after the update.

Each gateway file ID corresponding to the user 1901 who updated the user management table 319 is determined by referring to the stub file 371 (S3007). Subsequently, the file having the determined gateway file ID is rearranged (S3008). The file rearrangement is carried out by downloading the file from a public cloud 500 having an above-determined arrangement planned cloud number identical before and after the update, deleting the file from public clouds 500 having the arrangement planned cloud numbers used before the update and not used after the update, and uploading the file to public clouds 500 having the arrangement planned cloud numbers not used before the update and used after the update. The destination of the download (source of the upload) in this case is the file 372 of the volume 370. The download, upload and deletion are carried out by activating the web access unit 311 while specifying the gateway file ID as explained above. Finally, the file arrangement management table 320 is updated corresponding to the contents of the file rearrangement (S3009).

As explained above, files can be rearranged so as to guarantee the target SLA in the extension metadata table 317 based on the updated user management table 319.

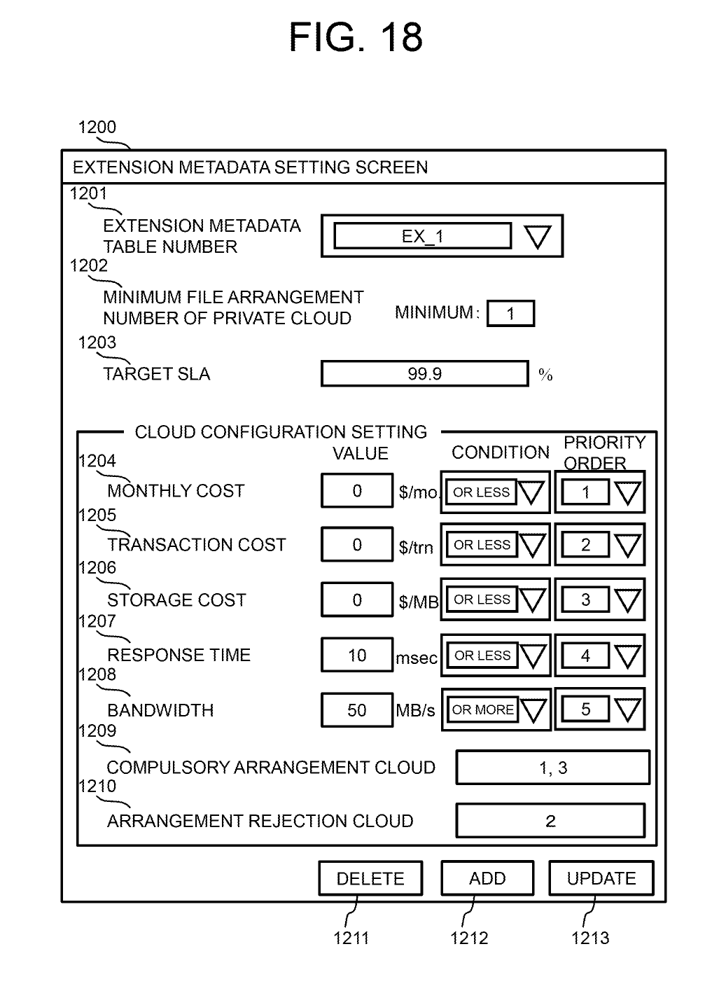

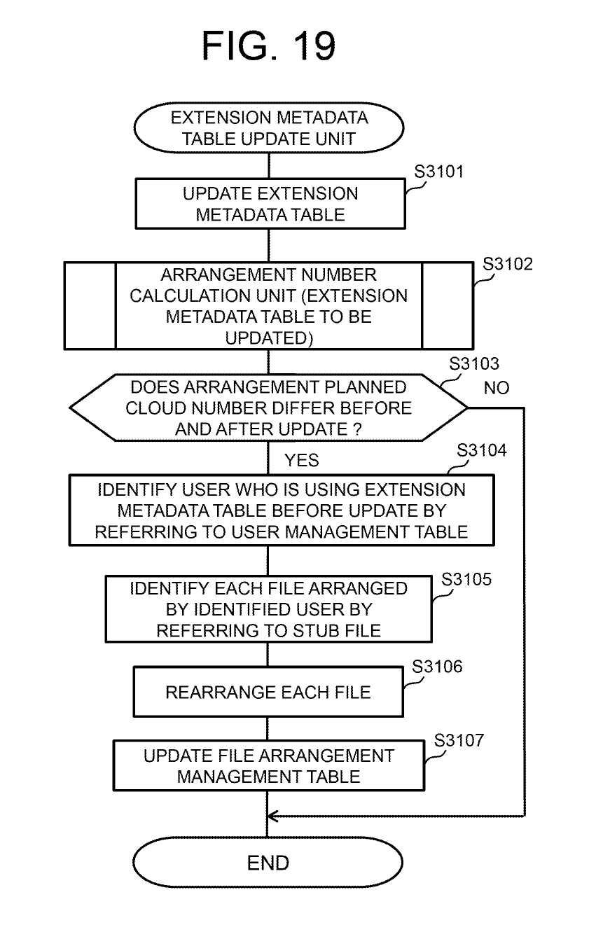

(6) Process Executed in Response to Change in File Arrangement Condition (FIG. 18, FIG. 19)

FIG. 18 shows an example of an extension metadata setting screen 1200 of the management terminal 200. Corresponding to the items of the extension metadata table 317, the extension metadata setting screen 1200 displays the following items and receives inputs (e.g., alteration of the contents of an item) from the manager. The extension metadata setting screen 1200 displays items such as extension metadata table number 1201, private cloud minimum arrangement number 1202, target SLA 1203, monthly cost 1204, transaction cost 1205, storage cost 1206, response time 1207, bandwidth 1208, compulsory arrangement cloud 1209 and arrangement rejection cloud 1210 and receives inputs for changing the contents of the items. The monthly cost 1204, the transaction cost 1205, the storage cost 1206, the response time 1207, the bandwidth 1208, the compulsory arrangement cloud 1209 and the arrangement rejection cloud 1210 are items for setting the cloud configuration. In the CLOUD CONFIGURATION SETTING, the value, condition and priority order of each item are displayed and inputs for changing the contents of the items are received. The extension metadata setting screen 1200 further includes a deletion button 1211 to be pressed for commanding deletion of the extension metadata table 317 having the extension metadata table number 1201, an addition button 1212 to be pressed for commanding addition of a new extension metadata table 317 having the contents of the settings made on the extension metadata setting screen 1200, and an update button 1213 to be pressed for commanding update of the extension metadata table 317 to the contents of the settings made on the extension metadata setting screen 1200. An extension metadata table update unit (not shown in FIG. 4) is activated in response to the instruction input through each button.

FIG. 19 is an example of a processing flow chart of the extension metadata table update unit. The contents of the extension metadata table 317 to be updated and the contents of the entry (line) of the arrangement planned cloud table 318 corresponding to the extension metadata table 317 to be updated are reserved (saved) in the work area and then the extension metadata table 317 is updated (S3101). The arrangement number calculation unit 315 is activated while specifying the extension metadata table 317 to be updated. The arrangement number calculation unit 315 updates the arrangement planned cloud number 1802 corresponding to the extension metadata table 317 to be updated as explained above.

Whether the arrangement planned cloud number differs before and after the update of the extension metadata table 317 or not is judged by referring to the contents of the entry (line) of the arrangement planned cloud table 318 reserved (stored) in the work area (S3103). If different, the process advances to step S3104, otherwise the process ends.

The user who is using the extension metadata table 317 before the update is identified by referring to the user management table 319 (S3104). The file ID of each file arranged in the hybrid cloud by the identified user is identified by referring to the basic metadata 376 of the file (S3005). Each file having each identified file ID is rearranged (S3106) and the file arrangement management table 320 is updated according to the contents of the file rearrangement (S3107). The file rearrangement and the update of the file arrangement management table 320 are equivalent to the steps S3008 and S3009 executed by the user management table update unit, and thus repeated explanation thereof is omitted for brevity.

As explained above, the clouds in which each file should be arranged so as to satisfy the SLA can be determined properly based on the updated extension metadata table.

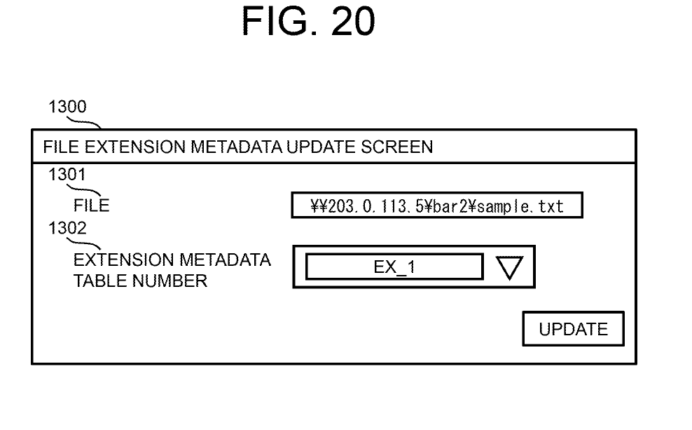

(6) Process Executed in Units of Files in Response to Change in File Arrangement Specification (FIG. 20)

While the update of an arrangement specification was performed in units of users in the aforementioned process (5), a process in a case where an arrangement specification of a particular file is changed will be explained below. FIG. 20 shows an example of a file extension metadata update screen 1300 of the management terminal 200. The file extension metadata update screen 1300 displays the following items and receives inputs for changing the extension metadata from the manager in units of files. The item 1301 is an input part for inputting the user file ID of the file as the target of the update. The item 1302 is a selection part for selecting one of the extension metadata tables that should be assigned to the file specified in the input part 1301. In regard to the target file specified by the file ID inputted to the file extension metadata update screen by the manager, a user file extension metadata update unit 321 updates the extension metadata 377 to the specified extension metadata table number. The subsequent steps are equivalent to the steps S3102-S3107 in the processing flow chart (FIG. 19) of the extension metadata table update unit, and thus repeated explanation thereof is omitted for brevity. Incidentally, it is sufficient to execute the arrangement number calculation unit (step S3102) only for the file for which the extension metadata is updated. While the input of the user file ID is received in this embodiment, it is also possible to receive the input of the gateway file ID.

As explained above, the arrangement specifications can be changed in units of files by changing the extension metadata for each file specified by the manager.

According to this embodiment, the number of duplication files stored in the public clouds and the private cloud can be reduced and the management cost can be cut down while satisfactory file storage availability is secured.

### DESCRIPTION OF REFERENCE CHARACTERS

100 client terminal
200 management terminal
300 gateway
311 web access unit
312 file server unit
313 cloud configuration management unit
314 file arrangement management unit
315 arrangement number calculation unit
316 cloud configuration definition table
317 extension metadata table
318 arrangement planned cloud table
319 user management table
320 file arrangement management table
400 private cloud
500 public cloud

1. A file storage service system operated by a computer which is connected to a client terminal and a hybrid cloud via a network, the hybrid cloud for storing a file uploaded from the client terminal, wherein the computer comprises:
an extension metadata table which stores conditions and target availability for storage of a file to the hybrid cloud;
an arrangement planned cloud table which stores a first identifier of a first cloud included in the hybrid cloud in association with the extension metadata table;
an arrangement number calculation unit which selects a second cloud included in the hybrid cloud and satisfying the conditions stored in the extension metadata table and stores an identifier of the selected second cloud as the first identifier of the first cloud in the arrangement planned cloud table when availability of the selected second cloud satisfies the target availability; and
a file arrangement management unit which refers to the extension metadata table associated with a file in response to reception of the file from the client terminal via the network, acquires the first identifier of the first cloud stored in the arrangement planned cloud table, and stores the file in the first cloud identified by the acquired first identifier.

2. The file storage service system according to claim 1, wherein:
when the availability of the selected second cloud does not satisfy the target availability, the arrangement number calculation unit selects a third cloud included in the hybrid cloud and satisfying the conditions stored in the extension metadata table, and
when combined availability of the selected second and third clouds satisfies the target availability, the arrangement number calculation unit stores the identifiers of the selected second and third clouds as the first identifier of the first cloud in the arrangement planned cloud table.

3. The file storage service system according to claim 2, wherein:
the hybrid cloud includes a private cloud used for storing files of the client terminal only and a public cloud used also for storing files other than those of the client terminal, and
the first cloud identified by the first identifier is the public cloud.

4. The file storage service system according to claim 3, wherein:
when the combined availability of the selected second and third clouds does not satisfy the target availability, there is no other cloud included in the hybrid cloud and satisfying the conditions stored in the extension metadata table, and combined availability of the selected second and third clouds and the private cloud satisfies the target availability, the arrangement number calculation unit stores the identifiers of the selected second and third clouds as the first identifier of the first cloud in the arrangement planned cloud table and stores a planned storage number, indicating the number of identical files to be stored in the private cloud, in the arrangement planned cloud table, and
the file arrangement management unit stores a certain number of files identical with the file in the private cloud while setting the number at the planned storage number.

5. The file storage service system according to claim 1, wherein:
in response to update of the extension metadata table, the arrangement number calculation unit selects a cloud included in the hybrid cloud and satisfying conditions stored in the updated extension metadata table as the second cloud, and
when the availability of the selected second cloud satisfies the target availability, the arrangement number calculation unit stores the identifier of the selected second cloud as the first identifier of the first cloud in the arrangement planned cloud table.

6. The file storage service system according to claim 5, wherein in response to the update of the extension metadata table, the file arrangement management unit acquires the first identifier of the first cloud stored in the arrangement planned cloud table and stores the file in the first cloud identified by the acquired first identifier.

7. The file storage service system according to claim 1, wherein the conditions stored in the extension metadata table include at least cost and response time.

8. The file storage service system according to claim 5, wherein the update of the extension metadata table is carried out based on a file ID and an extension metadata table number inputted through a file extension metadata update screen, by updating extension metadata corresponding to a file identified by the inputted file ID into the inputted extension metadata table number.

9. A file storage service method for a file storage service system operated by a computer which is connected to a client terminal and a hybrid cloud via a network, the hybrid cloud for storing a file uploaded from the client terminal, wherein:
the computer comprises an extension metadata table which stores conditions and target availability for storage of a file to the hybrid cloud and an arrangement planned cloud table which stores a first identifier of a first cloud included in the hybrid cloud in association with the extension metadata table, the computer executing the steps of:
selecting a second cloud included in the hybrid cloud and satisfying the conditions stored in the extension metadata table;
storing an identifier of the selected second cloud as the first identifier of the first cloud in the arrangement planned cloud table when availability of the selected second cloud satisfies the target availability;
referring to the extension metadata table associated with a file in response to reception of the file from the client terminal via the network;
acquiring the first identifier of the first cloud stored in the arrangement planned cloud table; and
storing the file in the first cloud identified by the acquired first identifier.

10. The file storage service method according to claim 9, wherein the hybrid cloud includes a private cloud used for storing files of the client terminal only and a public cloud used also for storing files other than those of the client terminal.

11. The file storage service method according to claim 10, wherein:
when the availability of the selected second cloud does not satisfy the target availability, the computer selects a third cloud included in the hybrid cloud and satisfying the conditions stored in the extension metadata table, and
when combined availability of the selected second and third clouds satisfies the target availability, the computer stores the identifiers of the selected second and third clouds as the first identifier of the first cloud in the arrangement planned cloud table.

12. The file storage service method according to claim 11, wherein when the combined availability of the selected second and third clouds does not satisfy the target availability, there is no other cloud included in the hybrid cloud and satisfying the conditions stored in the extension metadata table, and combined availability of the selected second and third clouds and the private cloud satisfies the target availability, the computer stores the identifiers of the selected second and third clouds as the first identifier of the first cloud in the arrangement planned cloud table, stores a planned storage number, indicating the number of identical files to be stored in the private cloud, in the arrangement planned cloud table, and stores a certain number of files identical with the file in the private cloud while setting the number at the planned storage number.

13. The file storage service method according to claim 9, wherein:
in response to update of the extension metadata table, the computer selects a cloud included in the hybrid cloud and satisfying conditions stored in the updated extension metadata table as the second cloud, and
when the availability of the selected second cloud satisfies the target availability, the computer stores the identifier of the selected second cloud as the first identifier of the first cloud in the arrangement planned cloud table.

14. The file storage service method according to claim 13, wherein in response to the update of the extension metadata table, the computer acquires the first identifier of the first cloud stored in the arrangement planned cloud table and stores the file in the first cloud identified by the acquired first identifier.

15. The file storage service method according to claim 9, wherein the conditions stored in the extension metadata table include at least cost and response time.
